(19) United States
(12) Patent Application Publication
(10) Pub. No.: US 2025/0392466 A1
(43) Pub. Date: Dec. 25, 2025

(54) PASSWORD DATA PROCESSING APPARATUS AND METHOD

(71) Applicant: Smarter Silicon (Shanghai) Technologies Co., Ltd., Shanghai (CN)

(72) Inventor: Yuanguang HUANG, Shanghai (CN)

(21) Appl. No.: 19/245,226

(22) Filed: Jun. 20, 2025

(30) Foreign Application Priority Data
Jun. 21, 2024 (CN) 202410816915.3

(51) Int. Cl. H04L 9/32; H04L 9/08

(52) U.S. Cl. CPC H04L 9/3226; H04L 9/0869

(57) ABSTRACT

A password data processing method includes in response to a target instruction, generating first password data, determining a scrambling parameter, and performing encryption on the first password data according to the scrambling parameter to generate second password data, and receiving input password data, and in response to a verification request, performing verification on the input password data by a verification module according to the first password data within an effective period corresponding to the verification request, to obtain a verification result of the input password data. The second password data is used to be transmitted to the verification module outside the effective period.

### CROSS-REFERENCE TO RELATED APPLICATION

The present disclosure claims priority to Chinese Patent Application No. 202410816915.3, filed on Jun. 21, 2024, the entire content of which is incorporated herein by reference.

### TECHNICAL FIELD

The present disclosure relates to the password technology field and, more particularly, to a password data processing apparatus and a password data processing method.

### BACKGROUND

When entering a password, after performing a certain number of times of correlation power analysis (CPA) or differential power analysis (DPA) method, the plain text of the password is easily analyzed, causing leaking of passwords.

### SUMMARY

An aspect of the present disclosure provides a password data processing method. The method includes in response to a target instruction, generating first password data, determining a scrambling parameter, and performing encryption on the first password data according to the scrambling parameter to generate second password data, and receiving input password data, and in response to a verification request, performing verification on the input password data by a verification module according to the first password data within an effective period corresponding to the verification request, to obtain a verification result of the input password data. The second password data is used to be transmitted to the verification module outside the effective period.

An aspect of the present disclosure provides a password data processing apparatus, including a password generation module and a verification module. The password generation module is configured to generate first password data and second password data. The second password data is password data obtained by performing encryption on the first password data according to a scrambling parameter. The verification module is configured to receive input password data, and in response to a verification request, perform verification on the input password data according to the first password data within an effective period corresponding to the verification request, to obtain a verification result of the input password data. The second password data is used to be transmitted to the verification module outside the effective period.

An aspect of the present disclosure provides an electronic device, including one or more processors and one or more memories. The one or more memories store a computer program that, when executed by the one or more processors, causes the one or more processors to in response to a target instruction, generate first password data, determine a scrambling parameter, perform encryption on the first password data according to the scrambling parameter to generate second password data, and receive input password data, and in response to a verification request, perform verification on the input password data by a verification module according to the first password data within an effective period corresponding to the verification request, to obtain a verification result of the input password data. The second password data is used to be transmitted to the verification module outside the effective period.

### BRIEF DESCRIPTION OF THE DRAWINGS

FIG. 1 illustrates a schematic flowchart of a password data processing method according to some embodiments of the present disclosure.

FIG. 2 illustrates a schematic wave diagram showing power consumption according to some embodiments of the present disclosure.

FIG. 3 illustrates a schematic structural diagram of a password data processing apparatus according to some embodiments of the present disclosure.

FIG. 4 illustrates a schematic structural diagram of another password data processing apparatus according to some embodiments of the present disclosure.

FIG. 5 illustrates a schematic structural diagram of another password data processing apparatus according to some embodiments of the present disclosure.

### DETAILED DESCRIPTION OF THE EMBODIMENTS

The technical solutions of embodiments of the present disclosure are described in detail in connection with the accompanying drawings of embodiments of the present disclosure. Apparently, the described embodiments are only some embodiments of the present disclosure, and not all embodiments. Based on embodiments of the present disclosure, all other embodiments obtained by those skilled in the art without creative effort shall fall within the scope of the present disclosure.

The Correlation Power Analysis (CPA) method is a method of using a correlation factor between power consumption samples and the Hamming weights of processed data to analyze and recover a cryptographic key. In the method, during the process where a part or all of the cryptographic key bits participate in a password operation, a linear correlation between the Hamming weights or Hamming distances of intermediate results obtained from guessed keys and the measured power signals can be calculated according to the correlation between the power signals and the Hamming weights or Hamming distances of the intermediate data generated during the password computation to recover the cryptographic key.

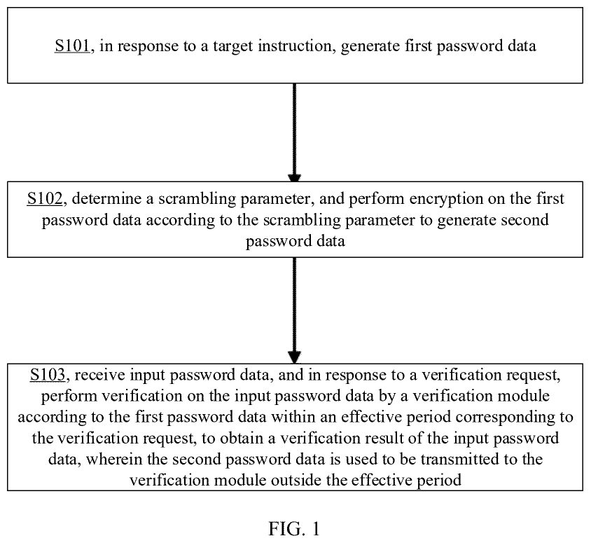

To prevent password leaks during input due to CPA or DPA attacks, embodiments of the present disclosure provide a password data processing method. FIG. 1 illustrates the flowchart of the method. The method includes the following steps.

At S101, in response to a target instruction, first password data is generated.

An execution body of the method of embodiments of the present disclosure can be any electronic device having a password verification function.

The electronic device can obtain a target instruction according to a user operation to generate the first password data in response to the target instruction. For example, the electronic device can obtain the target instruction for setting the storage space permission according to the operation of the user for setting the permission of the storage space. In response to the target instruction, the electronic device can generate the first password data for controlling the storage space permission.

The electronic device can also obtain the target instruction according to the status of the electronic device to generate the first password data. For example, when the electronic device determines that the device has a joint test action group (JTAG) interface, the electronic device can obtain the target instruction for controlling the access permission of the JTAG interface. The electronic device can generate the first password data for controlling the access permission of the JTAG interface in response to the instruction.

The first password data can be a password randomly generated by the electronic device, a password obtained by the electronic device according to a user operation, or encrypted password data obtained by encrypting the previous password based on any one encryption algorithm of the existing technology.

At S102, a scrambling parameter is determined, and an encryption process is performed on the first password data according to the scrambling parameter to generate second password data.

The electronic device can determine the scrambling parameter in various methods.

In some embodiments, the method for determining the scrambling parameter can include, when the electronic device is configured with a random number generation assembly, calling, by the electronic device, the random number generation assembly to generate a random number of a certain length, and determining the random number generated by the random number geeration assembly as the scrambling parameter.

The random generation assembly can be a physical electronic element, e.g., a random number generator integrated on the circuit board of the electronic device, or a non-physical program assembly, e.g., a function in the operating system of the electronic device for generating the random number.

In some other embodiments, the method for determining the scrambling parameter can include using a random number received by the input assembly as the scrambling parameter. Then, the electronic device can output first prompt information through the output assembly. The first prompt information can be used to instruct the user to input a random number of a certain length. After the user inputs the random number, the electronic device can determine the random number inputted by the user from the input assembly as the scrambling parameter.

The benefits of using the random number as the scrambling parameter can include enhancing the randomness of power consumption signals generated by the device during the encryption process, preventing identifiable patterns in the power consumption signals during the encryption process, and preventing the first password data from being analyzed from the power consumption signals during the encryption process using the CPA or DPA method.

The electronic device can perform the encryption process on the first password data according to the scrambling parameter in various ways. For example, the electronic device can realize the encryption process of step S102 based on any one of the following several (not limited) encryption methods.

In encryption method 1, the first password data can be converted into N-bit binary data, and the determined scrambling parameter can also be N-bit binary data. A bitwise operation can be performed on the first password data and the scrambling parameter to obtain a result as the second password data after the encryption process. For example, an AND operation can be performed on the first bit of the first password data and the first bit of the scrambling parameter to obtain the first bit of the second password data. An AND operation can be performed on the second bit of the first password data and the second bit of the scrambling parameter to obtain the second bit of the second password data, so on and so forth, to obtain the second password data.

In encryption method 2, the scrambling parameter can be used as the cryptographic key for encryption. Using any one encryption algorithm in the existing technology, the encryption process is performed on the first password data based on the cryptographic key to obtain the second password data.

In encryption method 3, the scrambling parameter can be inserted into various positions of the first password data to obtain the second password data after the encryption process.

At S103, input password data is received, and in response to the verification request, the verification process is performed by the verification module on the input password data according to the first password data in the effective period corresponding to the verification request. The second password data is transmitted to the verification module outside the effective period.

The electronic device can obtain the password data input by the user through the input module and obtain the input password data based on the password data input by the user.

In connection with the above example, when a user needs to access the storage space configured with permission or the JTAG interface configured with permission, the electronic device can output the second prompt information through the output assembly. The second prompt information can be used to prompt the user to input the password required for permission verification. Based on the password data input by the user, the electronic device can obtain the password data.

If the first password data is a password without encryption, the electronic device can directly use the string input by the user on the input assembly as the input password data. If the first password data is the password after the encryption based on any one encryption algorithm, the electronic device can perform the encryption process on the string input by the user on the input assembly and determine the encrypted data as the input password data.

The electronic device can obtain the verification request before obtaining the input password data. For example, the electronic device can generate the verification request when outputting the above second prompt information, or obtain the verification request after obtaining the input password data.

The electronic device can obtain the verification request in response to a user trigger operation after obtaining the input password data. For example, the electronic device can display a control element. The control element can display the text “Start Verification.” When the user clicks the control element, the electronic device can respond to the click operation and generate the verification request.

The electronic device can also obtain the verification request after determining that the input process for the input password data has ended. The electronic device can determine that the input process is ended after the user clicks the control element indicating the input process for the password is completed, or when the number of characters included in the string input by the user reaches a predetermined number. For example, when the password length is set to 10, the electronic device can determine that the input process is completed when the electronic device detects that the user has entered 10 characters in the password input field.

The effective period can be a time duration after the electronic device obtains the verification request. Alternatively, the verification request can be a signal lasting for a certain period. Then, the time duration in which the verification request lasts can also be used as the effective period. For example, if the verification request is a high-level signal lasting 3 seconds, the 3 seconds during which the high-level signal lasts can be used as the effective period.

In some embodiments, the effective period can be a time duration after obtaining the verification request. For example, the effective period may be 10 seconds after the verification request is obtained. If the electronic device obtains the verification request at time T0, the corresponding effective period can be from the time period T0 to T0+10 s.

In some embodiments, the effective period may not begin immediately after obtaining the verification request but may start after a time period. For example, the effective period can be 15 seconds starting 10 seconds after the verification request is obtained. If the electronic device obtains the verification request at time T0, the effective period can be a time period from T0+10 s to T0+25 s.

The electronic device can set the effective period according to a user operation. For example, if the user sets the length of the effective period to 10 seconds, the electronic device can determine the 10 seconds after obtaining the verification request as the effective period corresponding to the verification request.

The electronic device can also determine the effective period as follows.

According to a verification time length of the first password data, the effective period for completing the verification can be determined.

The verification time length can be a minimum time length required to complete the verification of the input password data according to the first password data.

For example, if 5 ms is needed to verify 10 bits of binary data, and the first password data can be converted into 60 bits of binary data. Then, the verification time length of the first password data can be 30 ms, i.e., the minimal time length needed to verify 60 bits of binary data.

The electronic device can determine a period equal to or slightly longer than the verification time length after obtaining the verification request as the effective period. In connection with the above example, when the verification time length is 30 ms, the effective period can be 30 ms or 50 ms after the verification request is obtained.

The verification process can include detecting, by the electronic device, whether the first password data is consistent with the input password data through the verification module. If the first password data is consistent with the input password data, the verification result of the input password data can be “Pass,” and if the first password data is not consistent with the input password data, the verification result of the input password data can be “Fail.”

The second password data can be transmitted to the verification module outside the effective period. That is, the first password data can only appear in the verification module in the corresponding effective period after the verification request is obtained. The verification module can only include the second password data outside the effective period without the first password data.

After the verification result is obtained, the electronic device can perform the corresponding operation according to the verification result. Based on the above, if the verification result is “Pass,” the electronic device can access the storage space or JTAG interface configured with permissions according to the user operation. If the verification result is “Fail,” the electronic device can refuse to access the storage space or JTAG interface configured with permissions and output a prompt indicating that access is refused from the output assembly.

The beneficial effects of embodiments of the present disclosure can include, on one aspect, the verification module can only perform verification on the input password data based on the first password data in the effective period corresponding to the verification request. Outside the effective period, the verification module can only have the encrypted second password data and cannot have the first password data without being encrypted using the scrambling parameter. Then, the time for the first password data appearing in the verification module can be significantly shortened. Thus, the risk of leaking the first password data due to the CPA or DPA attack can be lowered, and the safety of the first password data can be improved.

On another aspect, the second password data can be a password data encrypted with a random number. The random number for encryption can change dynamically without a certain pattern. Thus, the difficulty of analyzing the second password data and the first password data according to the power consumption signal can be increased to improve the safety of the

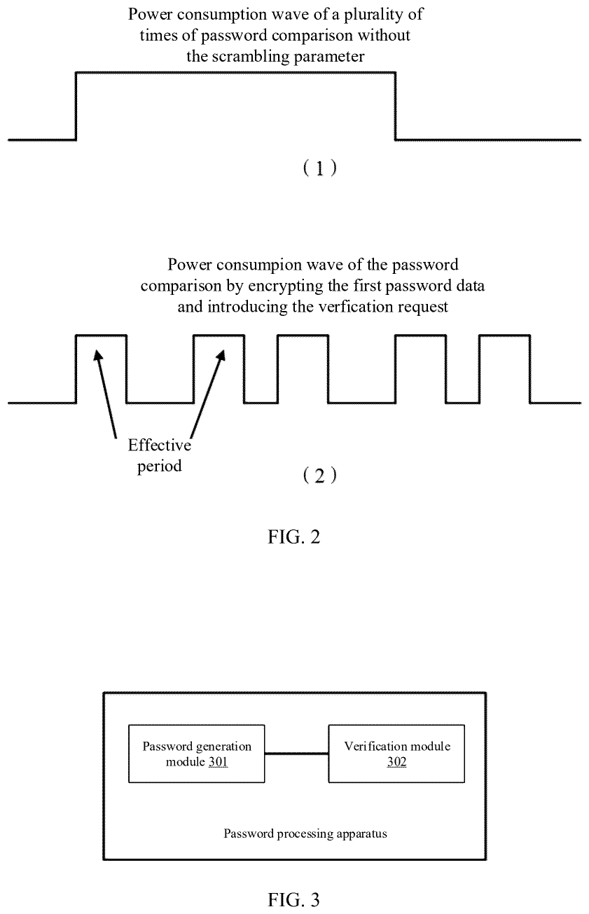

The beneficial effects of embodiments of the present disclosure are further described in connection with the power consumption wave diagram shown in FIG. 2.

FIG. 2 (1) shows a power consumption wave of the verification module when the electronic device verifies the input password data without using the scrambling parameter for the encryption process. The verification module can be in a high power consumption status for a long time. During this time, the verification module has the first password data. The power consumption data can be prone to being obtained by the attacker during this time. Then, the first password data can be recovered through the CPA or DPA method to cause password leaks.

FIG. 2 (2) shows a power consumption wave of the verification module when the electronic device verifies the input password data by using the scrambling parameter for the encryption process. The verification module can be in a high power consumption status in a short verification period, and can be in a low power consumption status for the rest of the time. The first password data can only be in the verification module during the verification period and may not appear in the verification module outside the verification period. Thus, in embodiments of the present disclosure, the time for the first password data to appear in the verification module can be reduced. Thus, the difficulty for the attacker to recover the first password data according to the power consumption data of the verification module when the first password data appears can be improved, and the probability of password leaks can be reduced.

In some embodiments, the electronic device can perform verification on the input password data in verification method 1 or verification method 2 below.

Verification method 1 can include decrypting the second password data that is transmitted to the verification module according to the scrambling parameter to obtain the first password data, and comparing the first password data and the input password data to obtain the verification result of the input password data.

When the verification is performed in the verification method 1, after the second password data is obtained by using the scrambling parameter for encryption, the scrambling parameter can be registered in any memory. Then, when the verification is needed, the registered scrambling parameter can be read from the memory to decrypt the second password data by using the scrambling parameter.

The method for decrypting the second password data can correspond to the method for encrypting the first password data.

When performing the encryption in encryption method 1, a reverse calculation corresponding to encryption method 1 can be performed on the second password data of N bits and the scrambling parameter of N bits based on a bitwise basis to obtain the first password data. When the encryption is performed in encryption method 2, based on a decryption algorithm corresponding to the encryption algorithm, the decryption can be performed on the second password data by using the scrambling parameter as the cryptographic key. When performing the encryption in encryption method 3, the scrambling parameter can be deleted from the position for inserting the scrambling parameter in the second password data to obtain the first password data.

The benefit of performing the verification in verification method 1 can include that the electronic device may not need to store the first password data, and may only need to store the second password data and the scrambling parameter. When the first password data is needed, the first password data can be obtained by decrypting the second password data. When the first password data is not needed, the first password data can be deleted. Thus, the first password data can be further protected from being stolen to improve the safety of the first password data.

In some embodiments, when performing the verification in verification method 1, the time length of the effective period can be greater than or equal to the sum of the verification time length and the decryption time length. The decryption time length can be the time length required to decrypt the second password data using the scrambling parameter.

Verification method 2 can include comparing the input password data with the first password data transmitted to the verification module within the effective period to obtain the verification result for the input password data.

In verification method 2, the electronic device can directly store the first password data in memory. After entering the effective period corresponding to the verification request, the electronic device can directly input the first password data into the verification module. The first password data can be compared with the input password data by the verification module to obtain the verification result.

Verification method 3 can include performing the encryption process on the input password data according to the scrambling parameter to obtain third password data, and comparing the second password data with the third password data through the verification module to obtain the verification result of the input password data.

The method for encrypting the input password data according to the scrambling parameter can be consistent with the method for encrypting the first password data according to the scrambling parameter.

In verification method 3, if the verification module detects that the second password data is consistent with the third password data after comparison, the first password data can also be determined to be consistent with the input password data. Then, the input password data can be determined to pass the verification. If the verification module detects that the second password data and the third password data are not consistent after the comparison, the first password data can be determined to be inconsistent with the input password data, indicating that the input password data fails the verification.

The benefit of verification method 3 includes that the first password data does not appear in the verification module during the verification process, which significantly improves the safety of the first password data.

In some embodiments, the number of the effective period can be one. The time length of the effective period can be greater than or equal to the verification time length corresponding to the first password data.

In some embodiments, the electronic device can finish performing the verification on all the input password data at once in the effective period to obtain the verification result of the input password data.

In some embodiments, the number of the effective periods can be multiple. A certain time interval can exist between two neighboring effective periods. The sum of the time lengths of the plurality of effective periods can be greater than or equal to the verification time length corresponding to the first password data.

The time lengths of the effective periods can be same or different. That is, the electronic device can determine a plurality of effective periods with different time lengths according to the verification time length corresponding to the first password data.

For example, if the number of the effective periods is 3, and the verification time length of the first password data is 30 ms, the electronic device can set the time lengths of the three effective periods to 10 ms or 15 ms. Alternavitvely, the electronic device can the time length of the first effective period corresponding to the verification request to be 10 ms, the time length of the second effective period corresponding to the verification request to be 15 ms, and the time length of the third effective period corresponding to the verification request to be 20 ms,

The electronic device can determine the fixed time interval between each two neighboring periods or randomly determine the time interval between each two neighboring periods. The time interval between each two neighboring periods can be the same or different.

For example, if the number of the effective periods is 3, the time interval between the first effective period and the second effective period can be 10 ms, and the time interval between the second effective period and the third effective period can be 15 ms when the verification request is obtained for the first time. The time interval between the first effective period and the second effective period can be 7 ms, and the time interval between the second effective period and the third effective period can be 13 ms when the verification request is obtained for the second time.

The different time lengths can be determined between the effective periods. Then, the power consumption signal of the verification module may not have a certain pattern in the verification process. Thus, the difficulty for the attacker to recover the first password data according to the power consumption signal can be further improved to improve the safety of the first password data.

In some embodiments, when the plurality of effective periods are provided, step S103 of performing the verification on the input password data can include performing the verification on a plurality of portions of the input password data according to the first password data in the plurality of effective periods to obtain a plurality of verification sub-results corresponding to the plurality of portions of the input password data, and determining the verification result of the input password data according to the plurality of verification sub-results.

When a plurality of effective periods are provided, the electronic device can first divide the input password data into a plurality of portions. Each portion can correspond to an effective period. When dividing, the length of the portion corresponding to each effective period can be determined according to the time length of each effective period to ensure that the verification of the portion can be completed in the effective period.

For example, if a verification request corresponds to 3 effective periods, the electronic device can divide the input password data into 3 portions and store the 3 portions in the memory of the electronic device. In the first effective period after obtaining the verification request, the electronic device can read the input password data of the first portion corresponding to the first effective period, and verify the input password data of the first portion to obtain the verification sub-result of the input password data of the first portion. The verification sub-result can include that the input password data of the first portion passes or fails the verification.

Similarly, the electronic device can perform the verification in the second effective period to obtain the verification sub-result of the input password data of the second portion and perform the verification in the third effective period to obtain the verification sub-result of the input password data of the third portion.

The method for verifying the input password data of each portion can be consistent with the method for verifying the whole input password above, which is not repeated here.

After the verification sub-results are obtained, if every verification sub-result is “Pass,” the verification result of the input password data can be determined to be “Pass.” If at least one verification sub-result is “Fail,” the verification result of the input password data can be determined to be “Fail.”

Embodiments of the present disclosure can further provide a password data processing apparatus. As shown in FIG. 3, the apparatus includes a password generation module 301 and a verification module 302.

The password generation module 301 can be configured to generate the first password data and the second password data. The second password data can be obtained by encrypting the first password data using the scrambling parameter.

The verification module 302 can be configured to receive the input password data, and, in response to a verification request, perform the verification on the input password data according to the first password data within the effective period corresponding to the verification request to obtain the verification result of the input password data. The second password data can be transmitted to the verification module outside the effective period.

In some embodiments, the method for obtaining the verification request can include obtaining the verification request after determining that the input process for the input password data ends.

In some embodiments, determining, by the verification module 302, the scrambling parameter can include at least one of determining the random number generated by the random number generation assembly as the scrambling parameter, or receiving the random number through the input assembly as the scrambling parameter.

In some embodiments, the verification module can also be configured to determine the effective period sufficient to complete the verification according to the verification time length of the first password data.

In some embodiments, one effective period can be provided, and the time length of the effective period can be greater than or equal to the verification time length corresponding to the first password data, or a plurality of effective periods can be provided, a certain time interval can exist between each two neighboring effective periods, and the sum of the time lengths of the plurality of effective periods can be greater than or equal to the verification time length corresponding to the first password data.

In some embodiments, when the plurality of effective periods are provided, the verification module 302 performing the verification on the input password data according to the first password data in the effective period corresponding to the verification request to obtain the verification result f the input password data can include performing the verification on the plurality of portions of the input password data according to the first password data in the plurality of effective periods to obtain the plurality of verification sub-results corresponding to the plurality of portions of the input password data, and determining the verification result of the input password data according o the plurality of verification sub-results.

In some embodiments, the verification module 302 can be configured to randomly determine the plurality of effective periods with different time lengths according to the verification time length corresponding to the first password data, and randomly determine the time interval between each two neighboring effective periods.

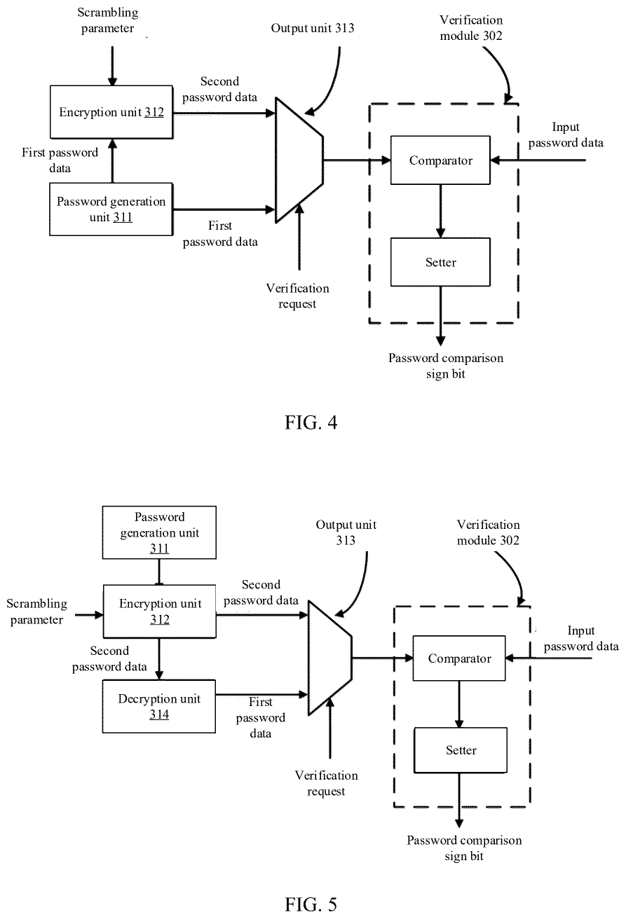

In some embodiments, as shown in FIG. 4, the password generation module includes a password generation unit 311, an encryption unit 312, and an output unit 313.

The password generation unit 311 can be configured to generate the first password data in response to the target instruction.

The encryption unit 312 can be configured to determine the scrambling parameter and perform encryption on the password data according to the scrambling parameter to generate the second password data.

The output unit 313 can be configured to output the first password data or the second password data to the verification module based on the verification request.

The password generation unit 311 and the encryption unit 312 can be any processor of the electronic device or a functional module arranged in any processor.

The input unit 313 can be any selector. An input end of the selector (i.e., the first input end) can be connected to the password generation unit 311 and can be configured to input the first password data. The other input end of the selector (i.e., the second input end) can be connected to the encryption unit 312 and can be configured to input the second password data.

The control end of the selector can be configured to input the verification request.

The output end of the selector can be connected to the comparator of the verification module 302. The verification module 302 can include the comparator and a setter.

The selector as the input unit 313 can connect the first input end and the output end in the effective period corresponding to the verification request after the verification request is obtained. Thus, the first password data can be transmitted to the comparator. Then, the second input end and the output end can remain disconnected. Outside the effective period corresponding to the verification request, the selector can connect the second input end and the output end, and the first input end and the output end can remain disconnected. Thus, the second password data can be transmitted to the comparator. Then, the comparator can only have the first password data in the effective period and may not have the first password data outside the effective period.

The output end of the comparator can be connected to the setter. The comparator can be configured to perform a comparison on the password data output by the output end of the selector and the input password data transmitted from the input assembly to obtain the comparison result and output the comparison to the setter.

The comparison result can be equivalent to the above verification result. The comparison result can indicate whether the password data output by the output end of the selector and the input password data transmitted from the input assembly are the same or different. When the comparison result indicates the same, the comparison result can be equivalent to the verification result of pass, and when the comparison result indicates the difference, the comparison result can be equivalent to the verification result of fail.

The setter can be configured to set the password and compare a sign bit according to the comparison result. If the comparison result indicates the same, the setter can set a password comparison sign bit to an unlocked state, e.g., 1. Thus, the electronic device can perform the operation subsequently locked by the first password data. For example, the electronic device can access the storage space or the JTAG interface configured with the permissions. If the comparison result indicates the difference, the setter can set the password comparison sign bit to a locked state, e.g., 0. Thus, the electronic device may not perform the operation subsequently locked by the first password data.

In some embodiments, the verification module 302 performing the verification on the input password data according to the first password data to obtain the verification result of the input password data can include comparing the input password data and the first password data that is transmitted to the verification module in the effective period to obtain the verification result of the input password data.

In some embodiments, the verification module 302 performing the verification can include decrypting the second password data transmitted to the verification module according to the scrambling parameter to obtain the first password data and comparing the first password data and the input password data to obtain the verification result of the input password data.

Then, as shown in FIG. 5, the password generation module includes the password generation unit 311, the encryption unit 312, the input unit 313, and the decryption unit 314.

The decryption unit 314 can be connected to the output end of the encryption unit 312. The output end of the decryption unit 314 can be connected to the input end of the output unit 313.

The encryption unit 312 can be configured to output the second password data to the decryption unit 314 after performing the encryption according to the scrambling parameter to obtain the second password data and register the scrambling parameter in any memory.

When the password generation module needs to output the first password data, the decryption unit 314 can read the scrambling parameter from the memory, decrypt the second password data using the scrambling parameter to obtain the first password data, transmit the first password data to the output unit 313, and provide the output unit 313 to the verification module 302 to complete the subsequent verification.

For the working principle of the password data processing apparatus of embodiments of the present disclosure, reference can be made to the relevant steps of the password data processing method of embodiments of the present disclosure, which is repeated here.

The various embodiments of the present disclosure are described in a progressive manner. Each embodiment focuses on differences from other embodiments. Similar or identical parts between embodiments can be cross-referenced.

To facilitate the description, when the above system or apparatus is described, the above system or apparatus can be divided into various modules or units based on functions. Of course, in embodiments of the present disclosure, the function of each unit can be realized in the same or different pieces of software and/or hardware.

From the description of the above embodiments of the present disclosure, those skilled in the art can clearly understand that the present disclosure can be implemented by means of software plus a necessary general hardware platform. Based on this understanding, the technical solution of the present disclosure, in essence or the part contributing to the existing technology, can be embodied in the form of a software product. The computer software product can be stored in a storage medium, such as ROM/RAM, magnetic disks, or optical disks, and include instructions to enable a computer device (e.g., a personal computer, server, or network device) to execute the methods described in the various embodiments or parts of the embodiments of the present disclosure.

In the present disclosure, relational terms such as “first,” “second,” “third,” and “fourth” are used solely to distinguish one entity or operation from another entity or operation, without necessarily requiring or implying any actual relationship or order between these entities or operations. Furthermore, the terms “include,” “comprise,” or any other variations thereof are intended to cover non-exclusive inclusion, so that a process, method, article, or device including a series of elements includes not only those elements but also other elements not explicitly listed or inherent to such process, method, article, or device. Without further limitation, an element defined by the phrase “including a . . . ” does not exclude the presence of additional identical elements in the process, method, article, or device that includes the element.

The above are some embodiments of the present disclosure. For those of ordinary skill in the art, various modifications and improvements can be made without departing from the principles of the present disclosure, and these modifications and improvements should also be within the scope of the present disclosure.

What is claimed is:

1. A password data processing method comprising:
in response to a target instruction, generating first password data;
determining a scrambling parameter, and performing encryption on the first password data according to the scrambling parameter to generate second password data; and
receiving input password data, and in response to a verification request, performing verification on the input password data by a verification module according to the first password data within an effective period corresponding to the verification request, to obtain a verification result of the input password data, wherein the second password data is used to be transmitted to the verification module outside the effective period.

2. The method according to claim 1, wherein performing the verification on the input password data by the verification module according to the first password data to obtain the verification result of the input password data includes:
decrypting the second password data transmitted to the verification module according to the scrambling parameter to obtain the first password data;
comparing the first password data and the input password data to obtain the verification result of the input password data; or
comparing the input password data with the first password data transmitted to the verification module within the effective period to obtain the verification result of the input

3. The method according to claim 1, wherein obtaining the verification request includes:
obtaining the verification request after determining that an input process of the input password data is completed.

4. The method according to claim 1, wherein determining the scrambling parameter includes at least one of:
determining a random number generated by a random number generation assembly as the scrambling parameter; or
receiving a random number as the scrambling parameter through an input assembly.

5. The method according to claim 1, further comprising:
determining the effective period capable of completing the verification according to a verification time length corresponding to the first password data.

6. The method according to claim 5, wherein:
one effective period is provided, and a time length of the effective period is greater than or equal to the verification time length corresponding to the first password data; or
a plurality of the effective periods are provided, a certain time interval exists between each two neighboring effective periods, and a sum of time lengths of the plurality of effective periods is greater than or equal to the verification time length corresponding to the first password data.

7. The method according to claim 6, wherein when the plurality of effective periods are provided, performing the verification on the input password data according to the first password data within the effective period corresponding to the verification request to obtain the verification result of the input password data includes:
performing the verification on a plurality of portions of the input password data according to the first password data within the plurality of effective periods to obtain a plurality of verification sub-results corresponding to the plurality of portions of the input password data; and
determining the verification result of the input password data according to the plurality of verification sub-results.

8. The method according to claim 6, further comprising:
randomly determining the plurality of effective periods with different time lengths according to the verification time length corresponding to the first password data, and randomly determining a time interval between each two neighboring effective periods.

9. A password data processing apparatus comprising:
a password generation module configured to generate first password data and second password data, wherein the second password data is password data obtained by performing encryption on the first password data according to a scrambling parameter;
a verification module configured to receive input password data, and in response to a verification request, perform verification on the input password data according to the first password data within an effective period corresponding to the verification request, to obtain a verification result of the input password data, wherein the second password data is used to be transmitted to the verification module outside the effective period.

10. The apparatus according to claim 9, wherein the password generation module includes:
a password generation unit configured to generate the first password data in response to a target instruction;
an encryption unit configured to determine the scrambling parameter, and perform encryption on the password data according to the scrambling parameter to generate the second password data; and
an output unit configured to output the first password data or the second password data to the verification module based on the verification request.

11. An electronic device comprising:
one or more processors; and
one or more memories storing a computer program that, when executed by the one or more processors, causes the one or more processors to:
in response to a target instruction, generate first password data;
determine a scrambling parameter, and perform encryption on the first password data according to the scrambling parameter to generate second password data; and
receive input password data, and in response to a verification request, perform verification on the input password data by a verification module according to the first password data within an effective period corresponding to the verification request, to obtain a verification result of the input password data, wherein the second password data is used to be transmitted to the verification module outside the effective period.

12. The device according to claim 11, wherein the one or more processors are further configured to:
decrypt the second password data transmitted to the verification module according to the scrambling parameter to obtain the first password data;
compare the first password data and the input password data to obtain the verification result of the input password data; or
compare the input password data with the first password data transmitted to the verification module within the effective period to obtain the verification result of the input password data.

13. The device according to claim 11, wherein the one or more processors are further configured to:
obtain the verification request after determining that an input process of the input password data is completed.

14. The device according to claim 11, wherein the one or more processors are further configured to perform at least one of:
determining a random number generated by a random number generation assembly as the scrambling parameter; or
receiving a random number as the scrambling parameter through an input assembly.

15. The device according to claim 11, wherein the one or more processors are further configured to:
determine the effective period capable of completing the verification according to a verification time length corresponding to the first password data.

16. The device according to claim 15, wherein:
one effective period is provided, and a time length of the effective period is greater than or equal to the verification time length corresponding to the first password data; or
a plurality of the effective periods are provided, a certain time interval exists between each two neighboring effective periods, and a sum of time lengths of the plurality of effective periods is greater than or equal to the verification time length corresponding to the first password data.

17. The device according to claim 16, wherein the one or more processors are further configured to:
perform the verification on a plurality of portions of the input password data according to the first password data within the plurality of effective periods to obtain a plurality of verification sub-results corresponding to the plurality of portions of the input password data; and
determine the verification result of the input password data according to the plurality of verification sub-results.

18. The device according to claim 16, wherein the one or more processors are further configured to:
randomly determine the plurality of effective periods with different time lengths according to the verification time length corresponding to the first password data, and randomly determine a time interval between each two neighboring effective periods.
